(19) United States
(12) Patent Application Publication
(10) Pub. No.: US 2010/0262994 A1
(43) Pub. Date: Oct. 14, 2010

(54) CONTENT PROCESSING DEVICE AND METHOD, PROGRAM, AND RECORDING MEDIUM

(76) Inventors: Shinichi KAWANO, Tokyo (JP); Tsugutomo Enami, Saitama (JP); Masaaki Isozu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/732,048

(22) Filed: Mar. 25, 2010

(30) Foreign Application Priority Data
Apr. 10, 2009 (JP) P2009-096304

(51) Int. Cl. H04N 5/445; G06F 17/30

(52) U.S. Cl. 725/39; 707/749; 707/E17.044

(57) ABSTRACT

A content processing device includes: a keyword acquiring means for acquiring a keyword for specifying content; a title acquiring means for acquiring a content title; a processing means for processing the acquired title on the basis of a predefined processing rule; a similarity calculating means for calculating similarity between the processed title and the keyword; and an identifying means for identifying content having a title specified by the keyword on the basis of the calculated similarity.

### BACKGROUND OF THE INVENTION

1. Field of the Invention

The present invention relates to a content processing device and method, a program, and a recording medium, and more particularly to a content processing device and method, a program, and a recording medium that can improve the satisfaction of a user by enabling the user to identify desired content on the basis of given information.

2. Description of the Related Art

When a recording reservation for a certain program as an object to be recorded is set in the case where a recording reservation for a program to be broadcast is made in related art, the recording fails since a program different from the program as the recording object is recorded if a broadcast time of the program of the recording object is changed.

As long as a recording object program can be identified from among latest EPG (Electronic Program Guide) data in a recording device capable of employing EPG data, it is possible to avoid a recording failure by correcting reservation content so that the identified program may be recorded.

There has been proposed a method of identifying a program by determining the similarity of program title information or the matching state of broadcast date information, or the like using EPG data (for example, see JP-A-2005-102059).

However, when an identification process is executed only by program title information without employing broadcast date information in the technique of JP-A-2005-102059, it is difficult to identify a program which is actually identical in spite of the fact that the program does not have a similar program title. For example, in the case where a program title expressed by EPG data is “Brown” when there is a program having a program title called [symbol] , it is difficult to actually identify the same program.

There has been proposed a system which identifies a program by converting Japanese characters (katakana) into Roman characters and determining whether a keyword is included in a target character string for each piece of information necessary to identify the program (for example, see JP-A-2007-201573).

### SUMMARY OF THE INVENTION

However, in the case where the identification process is executed only by the program title information even when the technique of JP-A-2007-201573 is used, it is difficult to exactly execute the identification process. For example, when there is a program having a program title called [symbol] [symbol] , a program title expressed by EPG data may be [symbol] [symbol] ˜Midnight˜”.

A name for identifying content among various pieces of content may be changed in various ways by convenience at a content handling side. For example, usually, a program title described in a magazine which introduces a television program, a web page on the Internet, or the like may not exactly match a program title expressed by EPG data.

For example, in the case of content to be re-broadcast, characters such as “rerun” may be usually added to the program title expressed by EPG data. In other cases, a sub-title or characters such as “special” added in response to a broadcast episode of a program may be added to a program title expressed by EPG data. In addition, a space or symbol included in the program title may be different from those of the EPG data and other media.

In the related art as described above, an actually identical program may not be identified and, for example, a desired program may not be recorded.

Thus, it is desirable to improve the satisfaction of a user by enabling the user to simply identify desired content on the basis of given information.

According to a first embodiment of the present invention, there is provided a content processing device including: a keyword acquiring means for acquiring a keyword for specifying content; a title acquiring means for acquiring a content title; a processing means for processing the acquired title on the basis of a predefined processing rule; a similarity calculating means for calculating similarity between the processed title and the keyword; and an identifying means for identifying content having a title specified by the keyword on the basis of the calculated similarity.

The content processing device may further include: an updating means for updating the processing rule.

The processing rule may include: a normalization rule to be used for a normalization process which deletes an unnecessary character included in a content title or converts a character style or a character attribute; and a reconfiguration rule to be used for a reconfiguration process which couples or deletes a character string of the content title normalized by the normalization process.

The content title may be a content title included in EPG data, and the normalization rule may include a rule which deletes a character string representing a broadcast episode in EPG data.

A recording reservation of the identified content may be set on the basis of the EPG data.

The content processing device may further include: a second processing means for processing the acquired keyword on the basis of a predefined processing rule.

The similarity calculating means may calculate similarity between the processed keyword and the title, and the identifying means may identify a keyword for specifying the title on the basis of the calculated similarity.

According to the first embodiment of the present invention, there is provided a content processing method included the steps of: acquiring a keyword for specifying content; acquiring a content title; processing the acquired title on the basis of a predefined processing rule; calculating similarity between the processed title and the keyword; and identifying content having a title specified by the keyword on the basis of the calculated similarity.

According to the first embodiment of the present invention, there is provided a program for causing a computer to function as a content processing device, including: a keyword acquiring means for acquiring a keyword for specifying content; a title acquiring means for acquiring a content title; a processing means for processing the acquired title on the basis of a predefined processing rule; a similarity calculating means for calculating similarity between the processed title and the keyword; and an identifying means for identifying content having a title specified by the keyword on the basis of the calculated similarity.

In the first embodiment of the present invention, a keyword for specifying content is acquired. A content title is acquired. The acquired title is processed on the basis of a predefined processing rule. Similarity between the processed title and the keyword is calculated. Content having a title specified by the keyword is identified on the basis of the calculated similarity.

According to a second embodiment of the present invention, there is provided a content processing device including: a keyword acquiring means for acquiring a keyword for specifying content; a title acquiring means for acquiring a content title; a processing means for processing the acquired keyword on the basis of a predefined processing rule; a similarity calculating means for calculating similarity between the processed keyword and the title; and an identifying means for identifying content having a title specified by the keyword on the basis of the calculated similarity.

In the second embodiment of the present invention, a keyword for specifying content is identified. A content title is acquired. The acquired keyword is processed on the basis of a predefined processing rule. Similarity between the processed keyword and the title is calculated. Content having a title specified by the keyword is identified on the basis of the calculated similarity.

According to embodiments of the present invention, it is possible to improve the satisfaction of a user by enabling the user to identify desired content on the basis of given information.

### BRIEF DESCRIPTION OF THE DRAWINGS

FIG. 1 is a diagram showing a configuration example of a content title identification system according to an embodiment of the present invention.

FIG. 2 is a block diagram showing a functional configuration example of the content title identification system of FIG. 1.

FIG. 3 is a diagram showing an example of a list of normalization rules.

FIG. 4 is a diagram showing an example of a list of reconfiguration rules.

FIG. 5 is a flowchart illustrating an example of a content title identification process.

FIG. 6 is a flowchart illustrating an example of a content title processing process.

FIG. 7 is a flowchart illustrating an example of a normalization process.

FIG. 8 is a flowchart illustrating an example of a reconfiguration process.

FIG. 9 is a diagram illustrating an example of keyword information.

FIG. 10 is a diagram illustrating an example of content metadata.

FIG. 11 is a diagram showing a correspondence table of keywords and content.

FIG. 12 is a block diagram showing another functional configuration example of the content title identification system of FIG. 1.

FIG. 13 is a block diagram showing a configuration example of a personal computer.

### DESCRIPTION OF THE EMBODIMENTS

Hereinafter, embodiments of the present invention will be described with reference to the drawings.

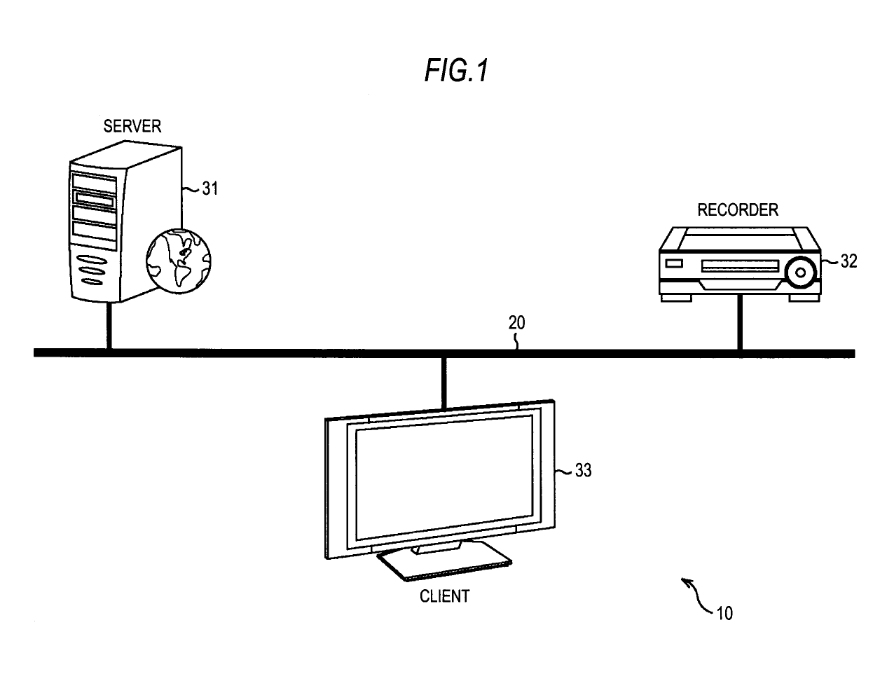

FIG. 1 is a diagram showing a configuration example of a content title identification system according to an embodiment of the present invention. A content title identification system 10 shown in the same figure includes a server 31, a recorder 32, and a client 33 connected to a network 20.

For example, the content title identification system 10 extracts keywords for retrieving a content title from information accumulated in the server 31 and identifies a title of content accumulated in the recorder 32 from the keywords. For example, content data corresponding to the identified title is associated with the keyword and is provided to the client 33.

For example, information retrieved and collected by users on the Internet is accumulated in the server 31. For example, the users retrieve their interest information and record the retrieved information to a recording medium such as an HDD (Hard Disk Drive) provided in the server 31 if desired. The server 31 has a function of extracting a keyword for retrieving a content title on the basis of the accumulated information, and extracts and provides the keyword in response to a request from the client 33. For example, the server 31 includes a general-purpose computer or the like. For example, the server 31 may be connected to the network 20 via the Internet or the like.

For example, the recorder 32 includes an HDD recorder, a DVD recorder, or the like and records content to the recording medium of the HDD or DVD. The recorder 32 has a function of extracting a title of content recorded to the recording medium and extracts and provides a title in response to a request from the client 33.

For example, the client 33 includes a television receiver or the like and internally includes a CPU, a memory, or the like. For example, the client 33 specifies a title of content corresponding to a keyword provided from the server 31 by executing software of a program or the like by the CPU. That is, the client 33 identifies a title of content recorded to the recorder 32 as a title of a given keyword.

For example, the content title identification system 10 includes equipment suitable for the UPnP specification. For example, it can be in a state in which communication is possible by joining a network without requesting the user to perform a complex operation using a UPnP function, and can automatically execute a detection or connection of other equipment. For example, the content title identification system 10 includes equipment corresponding to the DLNA (Digital Living Network Alliance) specification.

Accordingly, for example, the recorder 32 may function as a DMS (Digital Media Server) defined by the DLNA and the client 33 may function as a DMP (Digital Media Player) defined by the DLNA. In this case, for example, it is possible to acquire a content title by a CDS (Content Directory Service) function embedded in the DMS.

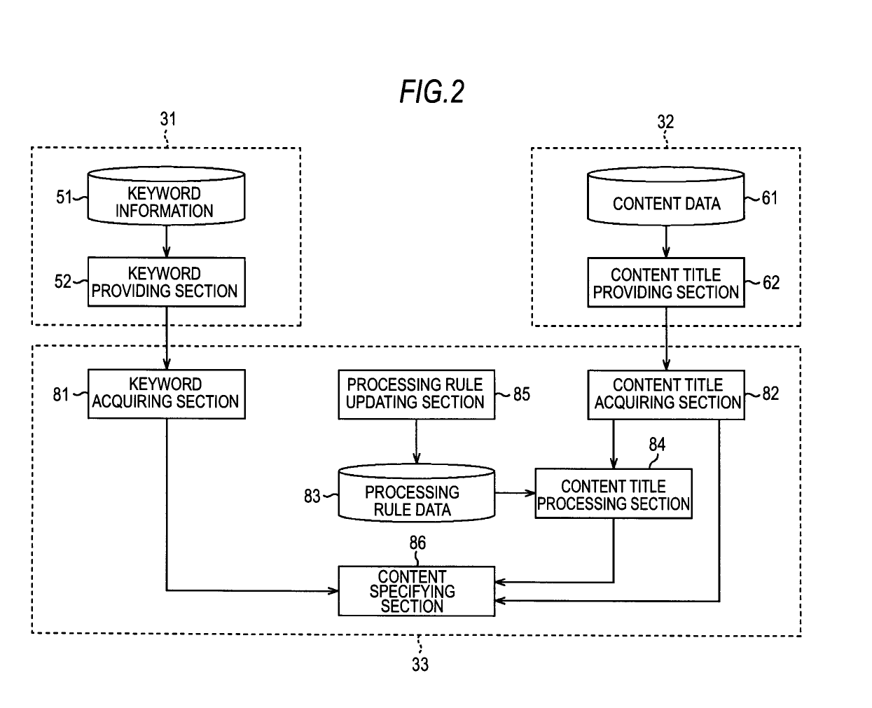

FIG. 2 is a block diagram showing a functional configuration example of the content title identification system 10 of FIG. 1.

In the same figure, keyword information 51 is regarded as a database storing each keyword extracted from information accumulated in the server 31. A keyword providing section 52 reads one or more predetermined keywords from the keyword information 51 in response to a request from a keyword acquiring section 81 and provides the read keywords to the keyword acquiring section 81. For example, the keyword acquiring section 81 acquires a keyword as text data.

The content data 61 represents a set of data of content accumulated in the recorder 32. Metadata acquired from each EPG or the like is added to the content data, and the content title providing section 62 extracts a content title from the content metadata of content data. The content title providing section 62 provides the content title acquiring section 82 with each extracted content title in response to a request from the content title acquiring section 82. For example, the content title acquiring section 82 acquires a content title as text data.

The content title processing section 84 processes a content title acquired by the content title acquiring section 82 on the basis of a processing rule supplied from processing rule data 83. Here, the term “processing” means that characters constituting a character string of text data are converted, some characters of the character string are deleted, and the order of a predetermined character is rearranged.

The processing rule data 83 stores a rule (information) when a keyword or a content title is processed. Here, the rule is used for a necessary process when a content title is identified, and corresponds to a type or attribute of a content title or a keyword.

For example, usually, a content title disclosed in a web page on the Internet which introduces a television program may not exactly match a content title included in EPG data. For example, this mismatch corresponds to the case where “new” (representing a new program), “rerun” (representing a rebroadcast), or “(final)” (representing the final episode) as specific characters of the EPG is added to a content title.

For example, information representing a broadcast episode of corresponding content is often added to a content title included in the EPG data. On the other hand, information representing a broadcast episode is typically not added to a general name of the corresponding content, and this may be one factor which makes the identification of a keyword and a content title difficult.

For example, a rule is defined such that “When a specific character string exists in the middle, characters thereof and subsequent characters are deleted. The specific character string is “new””.

For example, the mismatch between a content title described in a web page or the like and a content title included in EPG data may be usually caused by a difference of a full-width character and a half-width character. For example, in terms of information described in the web page or the like, a platform dependent character as a character adopted by a specific operating system or the like may be converted into a general-purpose character.

Here, for example, a rule is defined such that “All characters are converted into the half-width form when a conversion object character is in the middle in the case where the full-width and half-width forms exist as a character set of a content title”.

As described above, a process of deleting an unnecessary character included in the content title or converting an attribute of the content title itself or characters is referred to as a normalization process. A rule for the normalization process is referred to as a normalization rule.

The content title after the completion of the normalization process may also not exactly match a content title described in a web page or the like. This mismatch may be usually caused by a space or the like inserted into a character string.

Here, for example, a rule is defined such that “A full-width or half-width space is regarded as a separating character and first and second character strings which have been separated are directly connected”.

As described above, a process of coupling or deleting a character string of the content title after the completion of the normalization process is referred to as a reconfiguration process. A rule for the reconfiguration process is referred to as a reconfiguration rule.

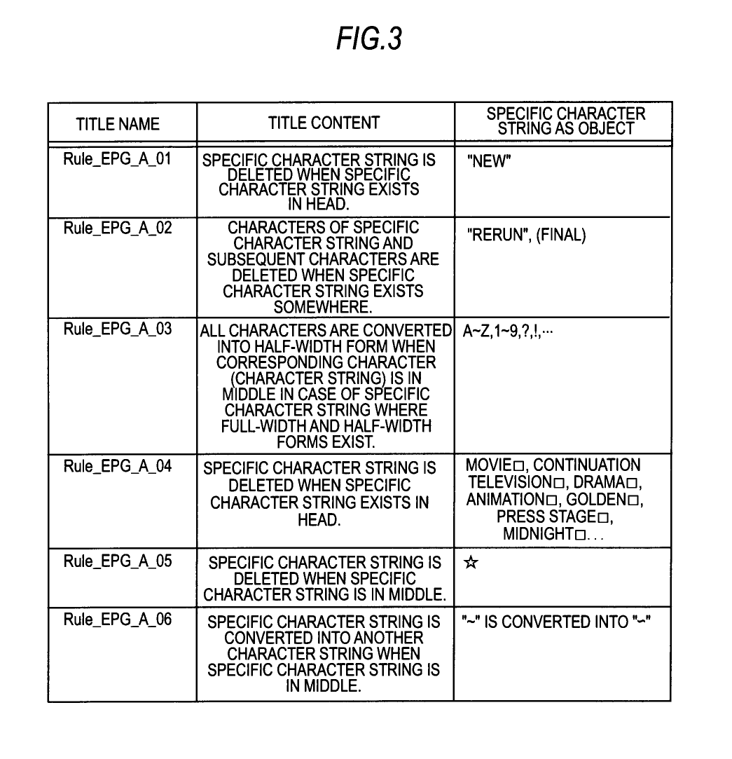

FIG. 3 is a diagram showing an example of a list of normalization rules stored in the processing rule data 83.

In this example, a rule name of a first rule is set as “Rule_EPG_A_01”. Likewise, second to sixth rule names are set as “Rule_EPG_A_02” to “Rule Rule_EPG_A_06”.

The rule content of the rule “Rule Rule_EPG_A_01” is that “A specific character string is deleted when the specific character string exists in the head”. The specific character string as the object may be “a character string including three characters for “new” (“parenthesis”, “new”, “parenthesis (closing)”)”. Here, a content title to which “new” is added represents that the content is a new program.

The rule content of “Rule Rule_EPG_A_02” means that “When a specific character string exists somewhere, characters thereof and subsequent characters are deleted”. The specific character string as the object may be “rerun” and “(final)”. Here, a content title to which “rerun” or “(final)” is added represents a rebroadcast or the final episode of the content.

The rule content of the rule “Rule Rule_EPG_A_03” means that “All characters are converted into the half-width form when a corresponding character (character string) is in the middle in the case of a specific character string where the full-width and half-width forms exist”. The specific string as the object may be “A to Z (referring to alphabets A to Z)”, “1 to 9 (referring to numerals 1 to 9), “?”, “!”, . . . .

The rule content of the rule “Rule Rule_EPG_A_04” means that “A specific character string is deleted when the specific character string exists in the head”. The specific character string as the object may be “Movie [symbol] ”, “Continuation Television [symbol] ”, “Drama [symbol] ”, “Animation [symbol] ”, “Golden [symbol] ”, “Press Stage [symbol] ”, “Midnight [symbol] ”, . . . . In the specific character string as the above-described object, “ [symbol] ” represents a full-width space.

The rule content of the rule “Rule Rule_EPG_A_05” means “A specific character string is deleted when the specific character string is in the middle”. The specific character string as an object may be “⋆”.

The rule content of the rule “Rule Rule_EPG_A_06” means that “A specific character string is converted into a predefined character string when the specific character string is in the middle”. The specific character string as the object may be “˜”, and “˜” is converted into “˜” (˜ represents the inversion of “˜”).

For example, when an EPG content title is “Drama [symbol] Journey 2009 [symbol] ˜Welcome˜ (final) (rerun) To Big Sky! [symbol] Departure Time”, the title normalized by the rules “Rule_EPG_A_01” to “Rule_EPG_A_06” becomes “Journey 2009 [symbol] ˜Welcome˜To Big Sky! [symbol] Departure Time”.

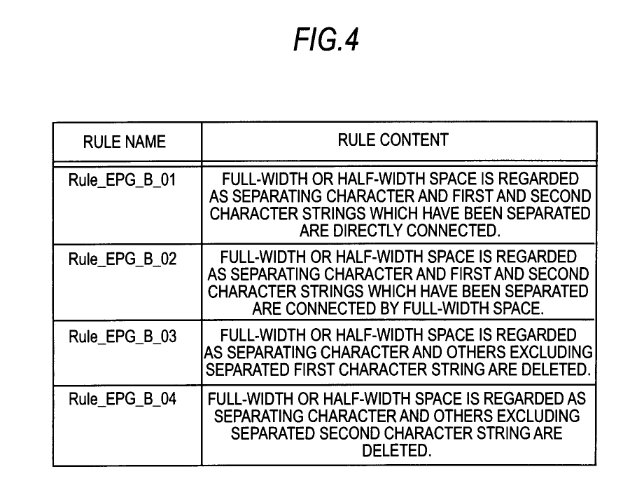

FIG. 4 is a diagram showing an example of a list of reconfiguration rules stored in the processing rule data 83.

In this example, the rule name of a first rule is “Rule_EPG_B_01”. Likewise, second to fourth rule names are “Rule_EPG_B_02” to “Rule_EPG_B_04”.

The rule “Rule_EPG_B_01” means that “A full-width or half-width space is regarded as a separating character and first and second character strings which have been separated are directly connected”.

For example, when a reconfiguration process by the rule “Rule_EPG_B_01” is applied to the above-described normalized title, the reconfigured title becomes “Journey 2009˜Welcome ˜To Big Sky! [symbol] Departure Time”.

The rule “Rule_EPG_B_02” means that “A full-width or half-width space is regarded as a separating character and first and second character strings which have been separated are connected by the full-width space”.

For example, when a reconfiguration process by the rule “Rule_EPG_B_02” is applied to the above-described normalized title, the reconfigured title becomes “Journey 2009˜Welcome ˜To Big Sky!˜Departure Time”, which is not different from the title before the reconfiguration. As described above, a title character string may not be processed even when the reconfiguration rule is applied.

The rule content of the rule “Rule_EPG_B_03” means that “A full-width or half-width space is regarded as a separating character and others excluding a separated first character string are deleted”. For example, a reconfiguration process by the rule “Rule_EPG_B_03” is applied to the above-described initialized title, the reconfigured title becomes “Journey 2009”.

The rule content of the rule “Rule_EPG_B_04” means that “A full-width or half-width space is regarded as a separating character and others excluding a separated second character string are deleted”. For example, a reconfiguration process by the rule “Rule_EPG_B_04” is applied to the above-described initialized title, the reconfigured title becomes “˜Welcome ˜To Big Sky!”.

FIGS. 3 and 4 respectively show examples of a normalization rule and a reconfiguration rule, which are not limited to the above-described rules. For example, the normalization rule and the reconfiguration rule may be changed in response to a type or attribute of the keyword information 51 or content data 61.

Returning to FIG. 2, the processing rule updating section 85 is constituted to update the normalization rule and the reconfiguration rule stored in the processing rule data 83. For example, the normalization rule and the reconfiguration rule are updated on the basis of a command of a user. For example, the processing rule updating section 85 may input a rule provided from a manager to the processing rule data 83 so that the normalization rule and the reconfiguration rule are updated by the manager of the normalization rule and the reconfiguration rule. In this case, for example, the processing rule updating section 85 may be connected to a device of the manager via a network or the like.

The content specifying section 86 calculates the similarity between a keyword supplied from the keyword acquiring section 81 and a processed title supplied from the content title processing section 84. The content specifying section 86 calculates the similarity between a keyword supplied from the keyword acquiring section 81 and a title before processing supplied from the content title acquiring section 82.

For example, it is desirable to calculate the similarity between the keyword and the title by dividing the keyword and each title by 2-gram (the case where n=2 in n-gram is referred to as bi-gram), recognizing a divided character string as a set, and calculating a jaccard coefficient.

For example, details of the n-gram are described in the following:

http://gihyo.jp/dev/serial/01/make-findspot/0005

For example, details of the jaccard coefficient are described in the following:

http://ibisforest.org/index.php?2.261264E+28942.2612 64E+289A8.602396E+2895% A45.556400E+2525A4%E6%B0

For example, the content specifying section 86 calculates the jaccard coefficient as described above for each title after processing and the keyword, and stores the jaccard coefficient as the similarity between each title after processing and the keyword. For example, the content specifying section 86 calculates the jaccard coefficient as described above for each title before processing and the keyword, and stores the jaccard coefficient as the similarity between each title before processing and the keyword.

The similarity calculation by the 2-gram and the jaccard coefficient described above is exemplary and the similarity may be calculated by other methods.

For example, the content specifying section 86 arranges calculated similarity values in descending order and identifies a title having the highest similarity as a content title corresponding to a keyword. Here, when the title having the highest similarity is the title after processing, the title before the corresponding processing is applied (that is, the title before processing) is identified as a content title corresponding to the keyword.

A plurality of high-level titles having high similarity may be identified as the content title corresponding to the keyword.

According to an embodiment of the present invention, for example, even when a content title included in EPG data does not match a content title described in other media of a web page or the like, the two may be identified.

Here, in order to simplify description, the functional blocks of FIG. 2 associated with the server 31 to the client 33 of FIG. 1 have been described, but the functional blocks are not necessary to be associated as described above. For example, one device may be constituted to include all the functional blocks of FIG. 2. All the functional blocks of FIG. 2 may be implemented by the recorder 32 and the client 33.

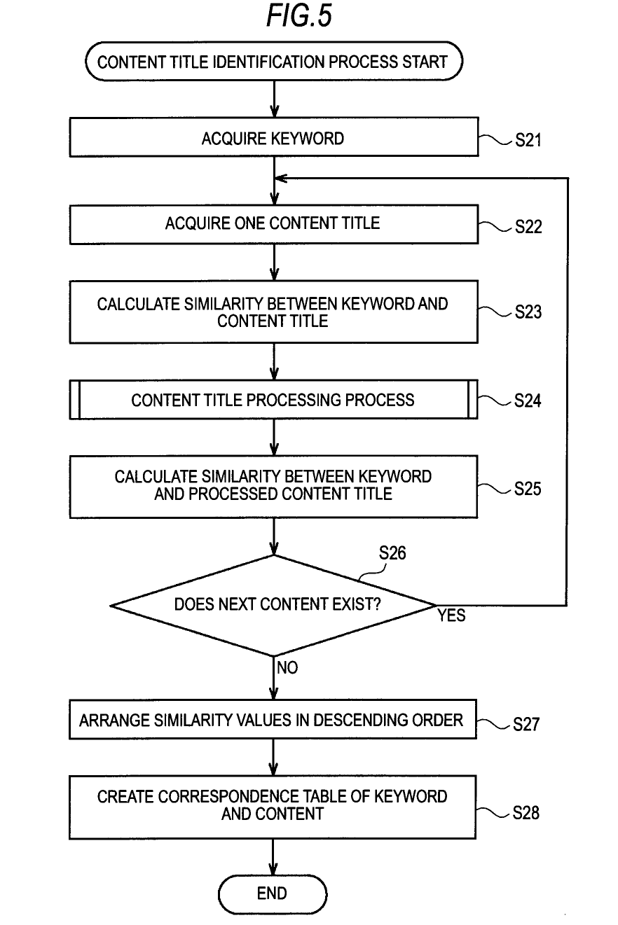

Next, an example of a content identification process by the client 33 will be described with reference to the flowchart of FIG. 5.

In step S21, the keyword acquiring section 81 acquires a keyword. At this time, for example, the keyword providing section 52 reads one or more predetermined keywords from the keyword information 51 and provides the read one or more predetermined keywords to the keyword acquiring section 81. For example, the keyword acquiring section 81 acquires the one or more keywords as text data.

In step S22, the content title acquiring section 82 acquires one content title. At this time, the content title providing section 62 extracts the content title from content metadata of content data and provides the extracted content title to the content title acquiring section 82. For example, the content title acquiring section 82 acquires the content title as text data.

In step S23, the content specifying section 86 calculates the similarity between the keyword acquired by the process of step S21 and the content title acquired by the process of step S22. At this time, for example, the similarity is calculated by dividing each of the keyword and the title by 2-gram, recognizing a divided character string as a set, and calculating a jaccard coefficient.

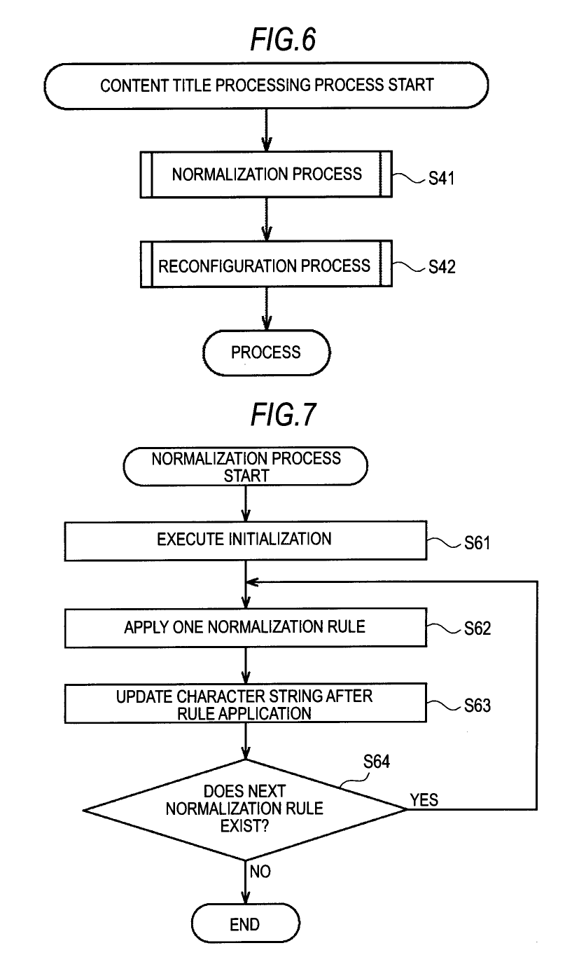

In step S24, the content title processing section 84 executes a content title processing process to be described later with reference to FIG. 6.

Here, a detailed example of the content title processing process of step S24 of FIG. 5 will be described with reference to the flowchart of FIG. 6.

In step S41, the content title processing section 84 executes a normalization process to be described later with reference to FIG. 7. Thus, the content title is normalized as described above.

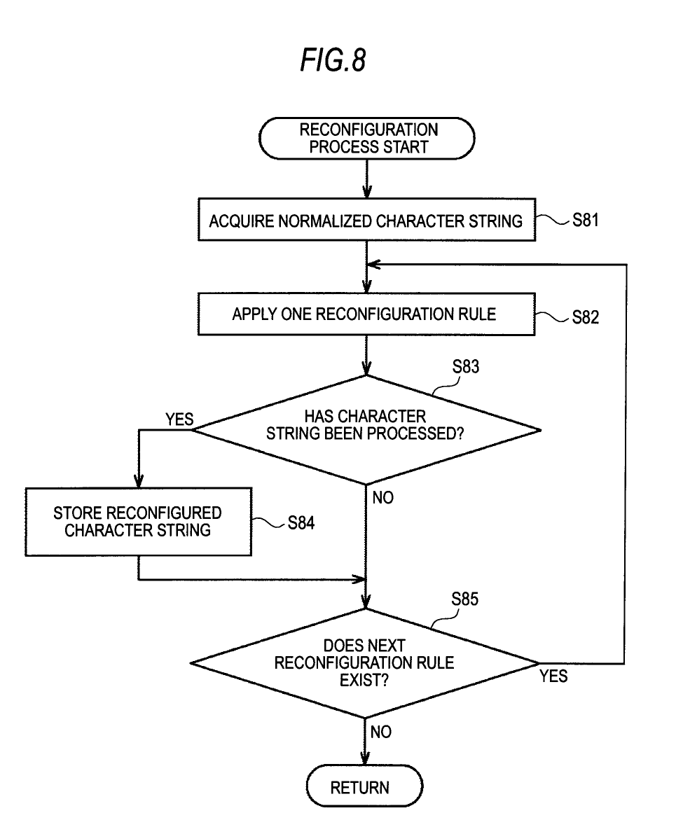

In step S42, the content title processing section 84 executes a reconfiguration process to be described later with reference to FIG. 8. Thus, the normalized content title is reconfigured as described above.

Next, a detailed example of the normalization process of step S41 of FIG. 6 will be described with reference to the flowchart of FIG. 7.

In step S61, the content title processing section 84 executes initialization. Here, for example, the initialization means a process of erasing text data as a previous processing object or returning a rule application sequence or the like to an initial value.

In step S62, the content title processing section 84 normalizes the content title by applying one normalization rule. For example, when the rules “Rule_EPG_A_01” to “Rule_EPG_A_06” are stored in the processing rule data 83 as in the example of FIG. 3, the normalization process is executed by first applying the rule “Rule_EPG_A_01”.

In step S63, the content title processing section 84 updates the character string to a character string after the rule application. For example, when the content title as an object to be processed is “Drama [symbol] Journey 2009 [symbol] ˜Welcome˜ (final) (rerun) To Big Sky! [symbol] Departure Time”, the character string after the application of the rule “Rule_EPG_A_01” is also “Drama [symbol] Journey 2009 [symbol] ˜Welcome˜ (final) (rerun) To Big Sky! [symbol] Departure Time”. Accordingly, in this case, “Drama□Journey 2009 [symbol] ˜Welcome˜ (final) (rerun) To Big Sky ! [symbol] Departure Time” is stored (updated) as the character string after the rule application.

In step S64, the content title processing section 84 determines whether or not the next normalization rule exists. In this case, since the rule “Rule_EPG_A_02” to the rule “Rule Rule_EPG_A_06” have yet not been applied, it is determined that the next normalization rule exists in step S64, and the process returns to S62.

In step S62, the next normalization rule is applied. In this case, the normalization is executed by applying the rule “Rule Rule_EPG_A_02”.

Thus, the character string after the rule application becomes “Drama [symbol] Journey 2009 [symbol] ˜Welcome˜To Big Sky! [symbol] Departure Time”, and the title character string is updated as described above in step S63.

Thereafter, the process of steps S62 to S64 is repeatedly executed until the normalization is executed by applying the rule “Rule Rule_EPG_A_03” to the rule “Rule Rule_EPG_A_06”. That is, when the rule “Rule Rule_EPG_A_06” has been applied in step S62, it is determined that the next normalization rule does not exist in step S64 and the normalization process is ended.

In the above-described example, the rules “Rule Rule_EPG_A_01” to “Rule Rule_EPG_A_06” are applied and the normalized title becomes “Journey 2009 [symbol] ˜Welcome˜To Big Sky! [symbol] Departure Time”. When the normalization process is ended, the above-described character string is stored.

Next, a detailed example of the reconfiguration process of step S42 of FIG. 6 will be described with reference to the flowchart of FIG. 8.

In step S81, the content title processing section 84 acquires the normalized character string. In the case of the above-described example, “Journey 2009 [symbol] ˜Welcome˜To Big Sky! [symbol] Departure Time” is acquired as the normalized character string.

In step S82, the content title processing section 84 applies one reconfiguration rule. For example, when the rule “Rule_EPG_B_01” to the rule “Rule_EPG_B_04” are stored in the processing rule data 83 as in the example of FIG. 4, the reconfiguration is executed by first applying “Rule_EPG_B_01”.

In the above-described example, when the reconfiguration process by the rule “RuleEPGB01” is applied to the character string acquired in step S81, the reconfigured title becomes “Journey 2009˜Welcome˜To Big Sky! [symbol] Departure Time”.

In step S83, the content title processing section 84 determines whether or not a character string has been processed. In this case, since the character string before the rule “Rule_EPG_B_01” is different from the character string after the rule “Rule_EPG_B_01”, it is determined that the character string has been processed in step S83, and the process proceeds to step S84.

In step S84, the content title processing section 84 stores the reconfigured string. Here, the stored character string is regarded as one processed title.

In step S85, the content title processing section 84 determines whether or not the next reconfiguration rule exists. In this case, since the rule “Rule_EPG_B_02” to the rule “Rule_EPG_B_04” have yet not been applied, it is determined that the next reconfiguration rule exists in step S85 and the process returns to step S82.

The next normalization rule is applied in step S82. In this case, the reconfiguration process is executed by applying the rule “Rule_EPG_B_02”.

For example, when the reconfiguration process by the rule

“Rule_EPG_B_02” has been applied in the above-described example, the reconfigured title becomes “Journey 2009 [symbol] ˜Welcome˜To Big Sky! [symbol] Departure Time”, which is not different from the title before the reconfiguration process. As described above, the title character string may not be processed even when the reconfiguration rule is applied.

In this case, it is determined that the character string has not been processed in step S83, and the process proceeds to step S85.

The process of steps S82 to S85 is repeatedly executed and the reconfiguration is executed by applying the rule “Rule_EPG_B_03” and the rule “Rule_EPG_B_04”.

When the rule “Rule_EPG_B_04” has been applied in step S82, it is determined that the next reconfiguration rule does not exist in step S85 and the reconfiguration process is ended.

When the normalization process is ended in the above-described example, character strings of reconfiguration process results of the rule “Rule_EPG_B_01”, the rule “Rule_EPG_B_03”, and the rule “Rule_EPG_B_04” are stored.

That is, the titles obtained by applying the content title processing process become three titles, “Journey 2009˜Welcome˜To Big Sky! [symbol] Departure Time”, “Journey 2009”, and “˜Welcome˜To Big Sky!”.

As described above, the content title processing process is executed.

Returning to FIG. 5, the process proceeds to step S25 after the process of step S24.

In step S25, the content specifying section 86 calculates the similarity between the keyword acquired by the process of step S21 and the processed title obtained as a result of the process of step S24. In the above-described example, since the number of processed titles is 3, 3 similarity values are calculated. The similarity is calculated in the same way as that of the case of step S23.

In step S26, the content specifying section 86 determines whether or not the next content exists. It is determined that the next content exists in step S26 until all content titles supplied from the content title providing section 62 are completely processed, and the process returns to step S22.

As described above, the process of steps S22 to S26 is repeatedly executed.

On the other hand, when all the content titles supplied from the content title providing section 62 have been completely processed, it is determined that the next content does not exist in step S26 and the process proceeds to step S27.

In step S27, the content specifying section 86 arranges similarity values calculated in step S23 or S25 in descending order. It is assumed that the similarity values are associated with the content titles.

In step S28, the content specifying section 86 creates a correspondence table of a keyword and content. At this time, for example, a predetermined number of content titles are selected as content titles having calculated similarity of high values which are equal to or greater than a threshold value, and are identified as the content titles corresponding to the keyword.

An example in which the process of steps S22 to S26 is repeatedly executed for each of individual pieces of content has been described, but a more efficient process may be executed as necessary. For example, the content title processing process of step S24 may be executed in advance for all pieces of content stored in the content data 61.

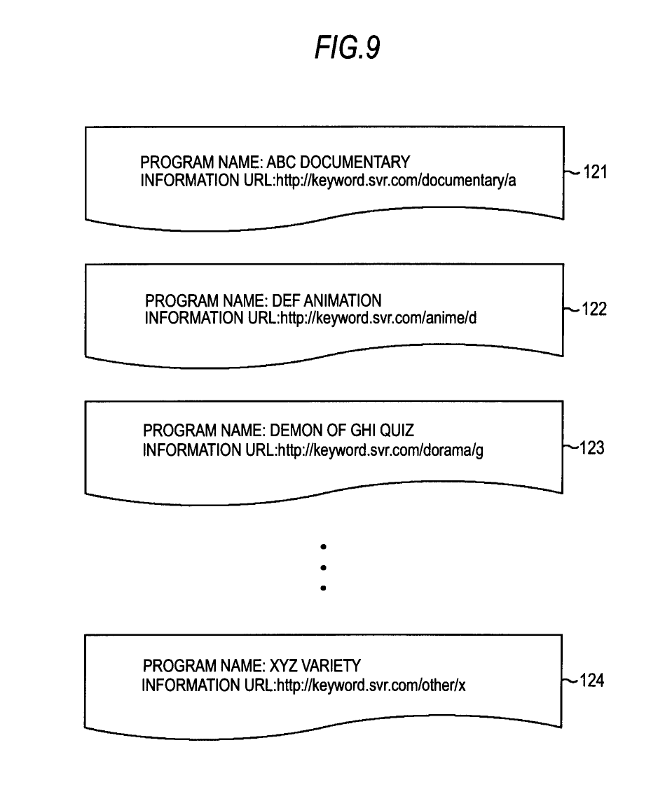

Description will be further given with reference to FIGS. 9 to 11.

FIG. 9 is a diagram showing an example of information stored in the keyword information 51 of FIG. 2 as information accumulated in the server 31. In this example, a “program name” as a content name acquired from a web page or the like which introduces content in another server connected to the Internet is described along with an “information URL” as address information of the web page.

For example, the information shown in the same figure is stored as records of the keyword information 51 constituted as a database.

Record 121 is content information of which a program name is “ABC Documentary”. Likewise, record 122 is content information of which a program name is “DEF Animation”, record 123 is content information of which a program name is “Demon of GHI Quiz”, . . . , record 124 is content information of which a program name is “XYZ Variety”.

The keyword providing section 52 reads information described as a program name from the record of the keyword information 51 as a keyword and provides the read information to the keyword acquiring section 81. The keyword acquiring section 81 acquires the program name of the record of the keyword information 51, which is made of text data, as a keyword. For example, in step S21 of FIG. 5, this process is executed.

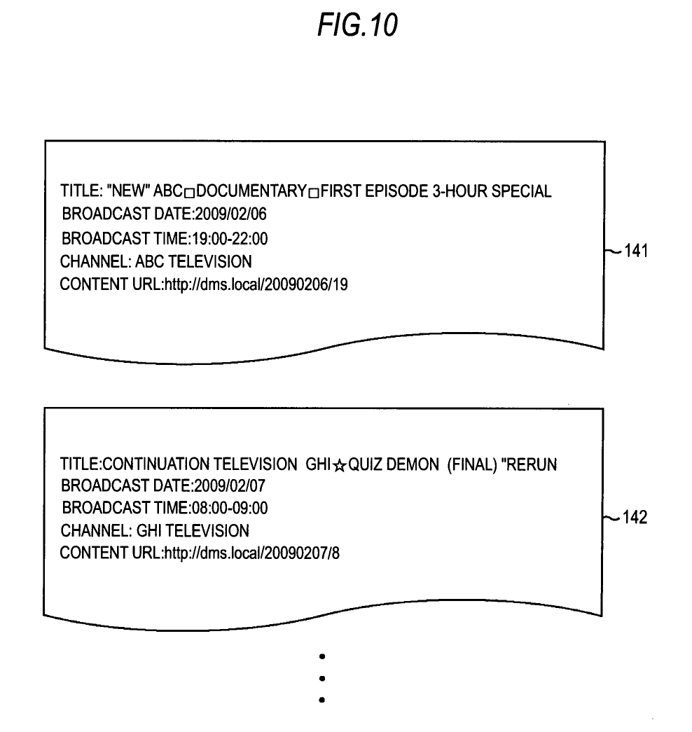

FIG. 10 is a diagram showing an example of information stored in the content data 61 of FIG. 2 as information accumulated in the recorder 32. For example, the information shown in the same figure is generated on the basis of metadata acquired from each EPG or the like which is made of information of metadata attached to content data.

In this example, information of “Title” representing a content title and “Broadcast Date”, “Broadcast Time” and “Channel” representing a broadcast date of corresponding content and a broadcast channel is described in metadata 141, metadata 142, . . . . Also information of “Content URL” as address information of a web page of a creator of corresponding content is described in the metadata 141, the metadata 142, . . . .

The content title providing section 62 extracts information described as a title from the metadata of the content data 61 and provides the extracted information to the content title acquiring section 82. For example, the content title acquiring section 82 acquires a metadata title of the content data 61, which is constituted by text data, as a content title. For example, in step S22 of FIG. 5, this process is executed.

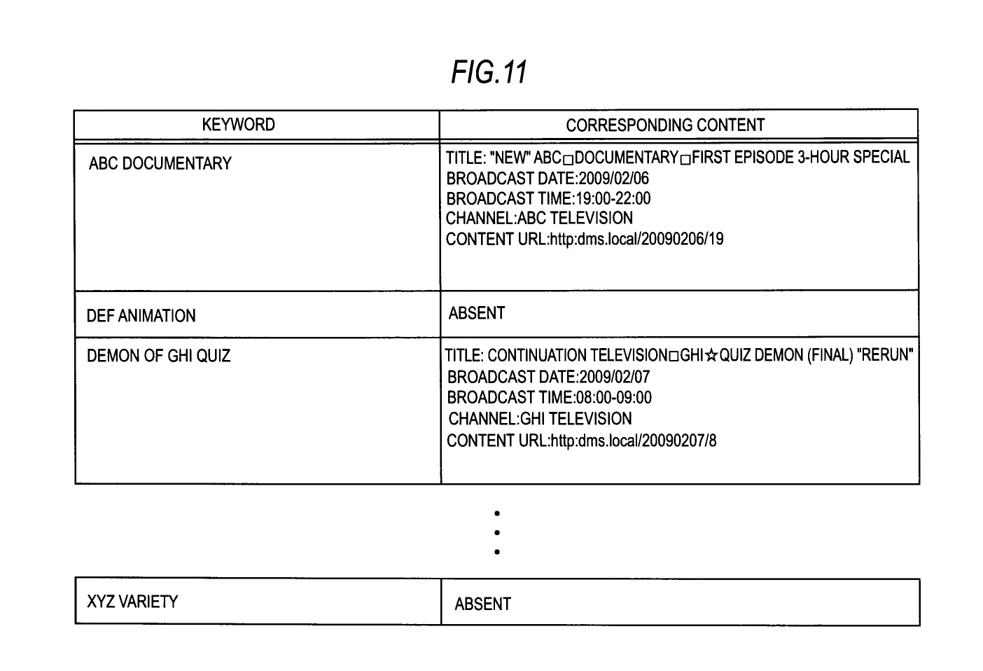

FIG. 11 is a diagram showing an example of a correspondence table of keywords and content. Here, for example, the client 33 executes a content title identification process in which a keyword corresponding to each record shown in FIG. 9 is designated.

As shown in the same figure, metadata of content corresponding to keywords “ABC Documentary”, “DEF Animation”, “Demon of GHI Quiz”, . . . , “XYZ Variety” is described in the correspondence table of the keywords and the content.

That is, the metadata 141 of FIG. 10 is described as content corresponding to the keyword “ABC Documentary” obtained from the record 121 of FIG. 9. The title of the metadata 141 is ““new”ABC [symbol] Documentary [symbol] First Episode 3-Hour Special”. When the similarity with “ABC Documentary” is directly calculated, the high similarity may not be obtained. That is, the similarity with the keyword obtained from the record 121 is increased by processing the title character string of the metadata 141 as described with reference to FIGS. 6 to 8, and content corresponding to the keyword can be identified.

The metadata 142 of FIG. 10 is described as content corresponding to the keyword “Demon of GHI Quiz” obtained from the record 123 of FIG. 9. The title of the metadata 142 is “Continuation Television [symbol] GHI⋆Quiz Demon (final) “rerun””. When the similarity with “Demon of GHI Quiz” is directly calculated, the high similarity may not be obtained. That is, the similarity with the keyword obtained from the record 123 is increased by processing the title character string of the metadata 142 as described with reference to FIGS. 6 to 8, and content corresponding to the keyword can be identified.

The content pieces corresponding to the keywords “DEF Animation” and “XYZ Variety” obtained from the records 122 and the record 124 of FIG. 9 are respectively described as “Absent”. That is, when there is no content title having the similarity with the corresponding keyword which is equal to or greater than a threshold value, the content corresponding to the keyword is regarded as “Absent”.

In step S28 of FIG. 5, for example, the correspondence table shown in FIG. 11 is generated.

In this example, one content piece corresponding to one keyword is identified. Alternatively, there is a plurality of content titles having similarity values which are equal to or greater than the threshold value, the plurality of content pieces corresponding to one keyword may be identified.

When the plurality of content pieces corresponding to one keyword are identified, an upper limit of the number of identified content pieces may be set. In this case, for example, 3 content pieces having high similarity values corresponding to one keyword may be identified.

Alternatively, when there are a plurality of content titles having similarity values which are equal to or greater than the threshold value, 3 content pieces corresponding to one keyword may be identified in order from the most recent record date/time.

For example, the client 33 prompts a display to display the correspondence table shown in FIG. 11. Thus, for example, the user of the client 33 can identify an item corresponding to content introduced on the Internet from among pieces of recorded content.

Alternatively, a thumbnail of identified content corresponding to the keyword may be further displayed as a GUI. On the basis of the displayed GUI, the identified content may be reproduced.

As described above, the content title identification process is executed.

An example in which content corresponding to the keyword is identified from among pieces of content recorded to the recorder 32 has been described above. Alternatively, according to an embodiment of the present invention, metadata corresponding to the keyword (for example, part of EPG data) may be identified.

In this case, for example, the client 33 obtaining the correspondence table shown in FIG. 11 may transmit a recording reservation command to the recorder 32 by the process described with reference to FIG. 5. Thus, the user can identify (specify) content corresponding to a desired keyword from EPG data and can make a recording reservation of the identified content on the basis of the EPG data.

For example, in the related art, it is difficult to identify a program when information of a broadcast date/time or the like is not known. When the identification process is executed only by program title information without using broadcast date information, it is not possible to identify a program which is actually identical in spite of the fact that the program does not have a similar program title.

There is a system which identifies a program by converting Japanese characters (katakana) into Roman characters and determining whether a keyword is included in a target character string. However, in the case where the identification process is executed only by the program title information, it is difficult to exactly execute the identification process.

A name for identifying content among various pieces of content may be changed in various ways by convenience at a content handling side. For example, usually, a program title described in a magazine which introduces a television program, a web page on the Internet, or the like may not exactly match a program title expressed by EPG data.

In the related art as described above, an actually identical program may not be identified and, for example, a desired program may not be recorded.

On the other hand, according to an embodiment of the present invention, it is possible to exactly identify content even when a name for identifying various pieces of content has been changed. Accordingly, the present invention can improve the satisfaction of the user.

An example in which content to be identified which corresponds to a keyword is content of a mainly broadcast program or the like has been described above, but it is not limited thereto. For example, content of moving image data provided on a moving-image posting site on the Internet or the like may be identified as content corresponding to the keyword.

An example in which a content title is processed using a normalization rule and a reconfiguration rule to easily determine the similarity with a keyword has been described above, but the keyword may be processed as necessary. For example, the similarity of the two may be determined by processing the content title and processing the keyword in response to an acquisition source of record information of the keyword information 51.

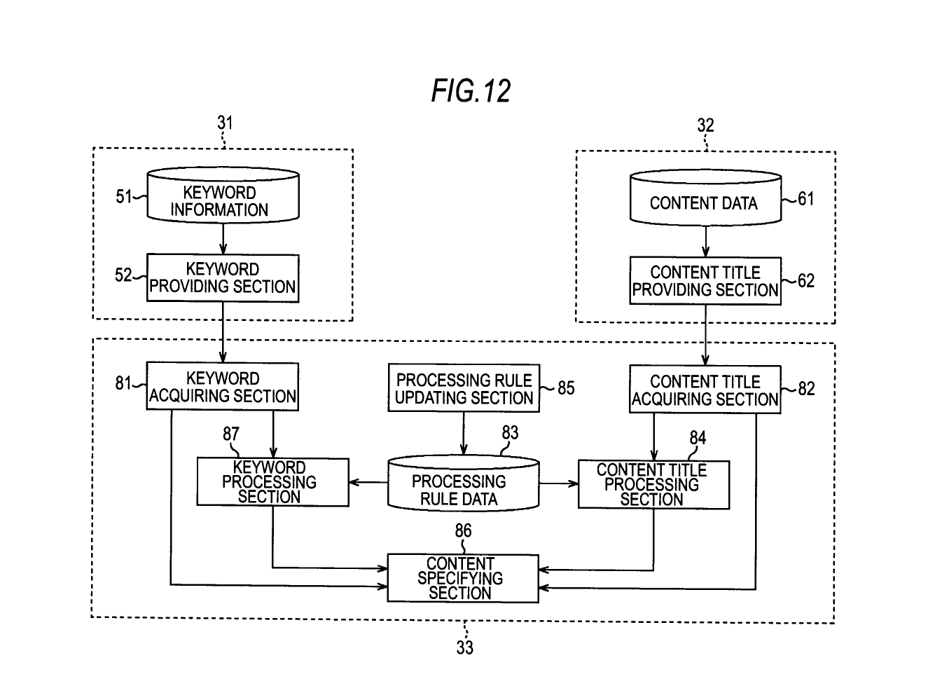

In this case, for example, it is desirable to apply the configuration shown in FIG. 12 in place of the configuration of FIG. 2. FIG. 12 is a block diagram showing another functional configuration example of the content title identification system 10 of FIG. 1. The same figure corresponds to FIG. 2, and the same elements are denoted by the same reference numerals. The configuration of FIG. 12 is different from that of FIG. 2 in that a keyword processing section 87 is installed. The other configuration of FIG. 12 is the same as that of FIG. 2.

In the configuration of FIG. 12, the keyword processing section 87 is constituted to process a keyword acquired by the keyword acquiring section 81 by applying the rule stored in the processing rule data 83. The keyword processing section 87 is not necessary to process the keyword by applying the normalization rule and the reconfiguration rule. For example, the keyword may be processed only by the normalization rule.

For example, in the configuration of FIG. 12, rules stored in the processing rule data 83 may be stored as rules which are divided into a rule to be used by the content title processing section 84 and a rule to be used by the keyword processing section 87.

Thus, for example, it is possible to appropriately execute the content title identification process even when a type of information stored in the keyword information 51 and a type of content stored in the content data 61 are arbitrarily changed.

An example of processing a content title to easily determine the similarity with the keyword has been described above, but the keyword may be processed to easily determine the similarity with the content title.

That is, the above example of the present invention of identifying content corresponding to a given keyword has been described, but the present invention may be applied even when a keyword corresponding to given content is identified. For example, a corresponding content title described on the Internet can be identified on the basis of corresponding content metadata when the user determines whether to record predetermined content by displaying EPG data. Thus, for example, the user can check in advance the estimation of content to determine whether or not to record the content.

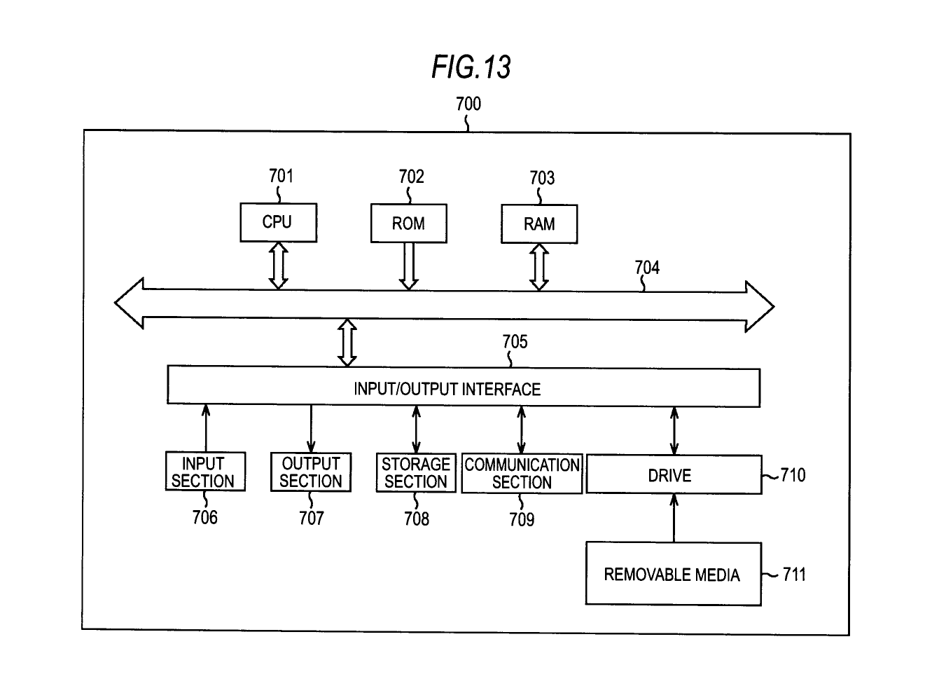

The series of processes described above may be executed by hardware or software. When the series of processes is executed by software, a program constituting the software is installed from a program recording medium in a computer embedded in dedicated hardware or, for example, a general-purpose personal computer 700 shown in FIG. 13 capable of executing various functions by installing various programs.

In FIG. 13, a CPU (Central Processing Unit) 701 executes various processes according to a program stored in a ROM (Read Only Memory) 702 or a program loaded from a storage section 708 to a RAM (Random Access Memory) 703. The RAM 703 also appropriately stores necessary data so that the CPU 701 executes various processes.

The CPU 701, the ROM 702, and the RAM 703 are mutually connected via a bus 704. An input/output interface 705 is also connected to the bus 704.

The input/output interface 705 is connected to an input section 706 including a keyboard, a mouse, and the like, a display including an LCD (Liquid Crystal display), an output section 707 including a speaker and the like, a storage section 708 including a hard disk and the like, and a communication section 709 including a modem, a network interface card of a LAN card, and the like. The communication section 709 executes a communication process through a network including the Internet.

If necessary, a drive 710 is connected to the input/output interface 705. Removable media 711 such as a magnetic disk, an optical disk, a magneto-optical disk, or a semiconductor memory are appropriately mounted. A computer program read therefrom is installed in the storage section 708 if necessary.

When the above-described series of processes is executed by software, a program constituting the software is installed from a network such as the Internet or a recording medium including the removable media 711 or the like.

This recording medium separated from the device main body shown in FIG. 13 includes a magnetic disk (including a floppy disk (registered trademark)), an optical disk (including a CD-ROM (Compact Disk-Read Only Memory) or DVD (Digital Versatile Disk), a magneto-optical disk (including an MD (Mini-Disk) (registered trademark)), the removable media 711 including a semiconductor memory or the like to which a program is recorded to distribute a program to the user. In a state in which the recording medium is embedded in advance in the device main body, the recording medium may be constituted by the ROM 702 recording a program to be transferred to the user or a hard disk included in the storage section 708.

Here, FIG. 13 has been described as a configuration example of a personal computer, but, for example, the same figure may be applied as the configuration example of the server 31 to the client 33 of the same figure. Functional blocks described with reference to FIG. 2 or 12 may be constituted by the CPU 701 operable to execute a predetermined step of a program, the storage section 708, or the removable media 711.

The series of processes described in the present specification includes a process to be executed in parallel or individually as well as a process to be chronologically executed.

The present invention is not limited to the above-described embodiments, and various changes are possible within a range without departing from the scope of the present invention.

The present application contains subject matter related to that disclosed in Japanese Priority Patent Application JP 2009-096304 filed in the Japan Patent Office on Apr. 10, 2009, the entire contents of which is hereby incorporated by reference.

What is claimed is:

1. A content processing device comprising:
a keyword acquiring means for acquiring a keyword for specifying content;
a title acquiring means for acquiring a content title;
a processing means for processing the acquired title on the basis of a predefined processing rule;
a similarity calculating means for calculating similarity between the processed title and the keyword; and
an identifying means for identifying content having a title specified by the keyword on the basis of the calculated similarity.

2. The content processing device according to claim 1, further comprising:
an updating means for updating the processing rule.

3. The content processing device according to claim 1,
wherein the processing rule includes:
a normalization rule to be used for a normalization process which deletes an unnecessary character included in a content title or converts a character style or a character attribute; and
a reconfiguration rule to be used for a reconfiguration process which couples or deletes a character string of the content title normalized by the normalization process.

4. The content processing device according to claim 3,
wherein the content title is a content title included in EPG data, and
wherein the normalization rule includes a rule which deletes a character string representing a broadcast episode in EPG data.

5. The content processing device according to claim 4,
wherein a recording reservation of the identified content is set on the basis of the EPG data.

6. The content processing device according to claim 1, further comprising:
a second processing means for processing the acquired keyword on the basis of a predefined processing rule.

7. The content processing device according to claim 6,
wherein the similarity calculating means calculates similarity between the processed keyword and the title, and
wherein the identifying means identifies a keyword for specifying the title on the basis of the calculated similarity.

8. A content processing method comprising the steps of:
acquiring a keyword for specifying content;
acquiring a content title;
processing the acquired title on the basis of a predefined processing rule;
calculating similarity between the processed title and the keyword; and
identifying content having a title specified by the keyword on the basis of the calculated similarity.

9. A program for causing a computer to function as a content processing device, comprising:
a keyword acquiring means for acquiring a keyword for specifying content;
a title acquiring means for acquiring a content title;
a processing means for processing the acquired title on the basis of a predefined processing rule;
a similarity calculating means for calculating similarity between the processed title and the keyword; and
an identifying means for identifying content having a title specified by the keyword on the basis of the calculated similarity.

10. A recording medium to which the program of claim 9 is recorded.

11. A content processing device comprising:
a keyword acquiring means for acquiring a keyword for specifying content;
a title acquiring means for acquiring a content title;
a processing means for processing the acquired keyword on the basis of a predefined processing rule;
a similarity calculating means for calculating similarity between the processed keyword and the title; and
an identifying means for identifying content having a title specified by the keyword on the basis of the calculated similarity.

12. A content processing device comprising:
a keyword acquiring unit configured to acquire a keyword for specifying content;
a title acquiring unit configured to acquire a content title;
a processing unit configured to process the acquired title on the basis of a predefined processing rule;
a similarity calculating unit configured to calculate similarity between the processed title and the keyword; and
an identifying unit configured to identify content having a title specified by the keyword on the basis of the calculated similarity.
